(19) United States
(12) Patent Application Publication
(10) Pub. No.: US 2011/0003956 A1
(43) Pub. Date: Jan. 6, 2011

(54) LINEAR PRECIPITATED POLYMER

(75) Inventors: Son Nguyen Kim, Hemsbach (DE); Ina Fast, Frankenthal (DE)

Correspondence Address: CONNOLLY BOVE LODGE & HUTZ, LLP, P O BOX 2207, WILMINGTON, DE, 19899, US

(73) Assignee: BASF SE, Ludwigshafen (DE)

(21) Appl. No.: 12/865,755

(22) PCT Filed: Jan. 28, 2009
(86) PCT No.: PCT/EP2009/050915

§ 371 Date: Aug. 2, 2010

(30) Foreign Application Priority Data
Feb. 1, 2008 (EP) 08150949.9

(51) Int. Cl. C08F 226/10

(52) U.S. Cl. 526/263

(57) ABSTRACT

The present invention relates to precipitation polymers obtainable by polymerization of a monomer mixture which comprises 30 to 99% by weight of at least one nonionic water-soluble monomer a) and at least one monomer b) different from a) selected from i) monomers carrying at least one hydroxyl group, ii) anionic monomers and iii) mixtures of i) and ii), if appropriate a monomer c) carrying at least one amino group, if appropriate further monomers, where the total amount of a), b), c) and d) is 100% by weight and where the monomer mixture, based on the total amount of a), b), c) and d), comprises less than 0.1% by weight of a monomer with at least 2 free-radically polymerizable double bonds per molecule. The invention furthermore relates to the use of these polymers as rheology modifiers for aqueous compositions, to aqueous compositions comprising these polymers and to the use of the polymers for thickening cosmetic and pharmaceutical preparations.

The present invention relates to precipitation polymers obtainable by polymerization of a monomer mixture which comprises 30 to 99% by weight of at least one nonionic water-soluble monomer a) and at least one monomer different from a) selected from i) monomers carrying at least one hydroxyl group, ii) anionic monomers and iii) mixtures of i) and ii), if appropriate a monomer c) carrying at least one amino group, if appropriate further monomers, where the total amount of a), b), c) and d) is 100% by weight and where the monomer mixture, based on the total amount of a), b), c) and d), comprises less than 0.1% by weight of a monomer with at least 2 free-radically polymerizable double bonds per molecule. The invention furthermore relates to the use of these polymers as rheology modifiers for aqueous compositions, to aqueous compositions comprising these polymers and to the use of the polymers for thickening cosmetic and pharmaceutical preparations.

Cosmetic, pharmaceutical and technical compositions are often subject to special requirements with regard to their rheological properties. Often, they can only be converted to the desired application form with the help of additives, so-called thickeners. Examples of customary low molecular weight thickeners are, for example, the alkali metal and aluminum salts of fatty acids, fatty alcohols or waxes. However, the use of the known thickeners is often associated with disadvantages, depending on the field of use of the preparation to be thickened. Thus, either the thickening effect of the thickener may not be satisfactory, its use may be undesired or its incorporation into the preparation to be thickened may be difficult or entirely impossible, for example because of its incompatibility with the compound to be thickened. Another disadvantage that often arises when using polymers as thickeners for producing relatively high viscosity or gel-like preparations is that as the molecular weight of the polymer increases, so its incorporation becomes generally more difficult, and that ultimately often only a swelling of the polymer is observed instead of the desired dissolution.

The provision of products with a complex profile of properties using the smallest possible fraction of, or fewest possible, different active substances often presents difficulties.

There is a need for polymers for cosmetic and other compositions which have good conditioning properties, i.e. have a positive influence on the sensory properties of the compositions comprising them, and at the same time allow an adjustment of the rheological properties of the compositions. In particular, the adjusted rheological properties should be largely stable even at high salt and/or surfactant contents. Cosmetic and pharmaceutical products are increasingly also subject to esthetic requirements from the consumer. Thus, preference is given to products which permit largely clear, transparent formulations. There is a need for cosmetically and pharmaceutically compatible polymers which are suitable for providing a certain profile of properties with regard to the sensory properties and the rheology. These should ideally be able to be converted to powders and nevertheless be capable of being incorporated into a composition within a short time and, in so doing, of reliably effecting the desired rheological properties.

WO 00/39176 describes a hydrophilic, cationic, ampholytic copolymer, which comprises, in copolymerized form, 0.05 to 20 mol % of an anionic monomer with at least one carboxyl group, 0 to 45 mol % of a cationic monomer with at least one amino group, and if appropriate a hydrophobic monomer and/or a crosslinker, where the molar ratio of cationic monomer to anionic monomer is about 2:1 to 16:1. These copolymers can, inter alia, be used for modifying rheological properties of body care compositions.

U.S. Pat. No. 3,915,921 describes copolymers which comprise, in copolymerized form, an olefinically unsaturated carboxylic acid, a C₁₀-C₃₀-alkyl (meth)acrylate and if appropriate a crosslinking monomer with at least two ethylenically unsaturated double bonds. In neutralized form they serve as thickeners for various applications.

WO 97/21744 describes crosslinked anionic copolymers and their use as thickeners and dispersants in aqueous systems.

EP-A-0 982 021 describes the use of (partially) neutralized copolymers of
A) 50 to 99% by weight of monoethylenically unsaturated carboxylic acids and
B) 1 to 50% by weight of at least one comonomer, selected from
a) monoethylenically unsaturated carboxylic acid esters with saturated C₈-C₃₀-alcohols,
b) N—C₈-C₁₈-alkyl- and N,N-di-C₈-C₁₈-alkylcarboxamides,
c) vinyl esters of aliphatic C₈-C₃₀-carboxylic acids, C₈-C₁₈-alkyl vinyl ethers, and
d) mixtures thereof as thickeners for the production of hair washing compositions.

U.S. Pat. No. 4,395,524 and U.S. Pat. No. 4,432,881 describe copolymers based on monomers containing amide groups that are effective as thickeners.

DE-A-42 13 971 describes copolymers which comprise, in copolymerized form, at least one olefinically unsaturated acid-group-containing monomer, at least one olefinically unsaturated quaternary ammonium compound, if appropriate at least one polyether (meth)acrylate and if appropriate at least one crosslinker, and their use as thickeners for thickening aqueous systems, which may be cosmetic preparations.

EP-A-893 117 and EP-A-913 143 describe crosslinked cationic copolymers and their use inter alia as hair-setting gel formers in cosmetic compositions.

EP-A-1 064 924 describes the use of crosslinked cationic polymers in skin cosmetic and dermatological preparations, inter alia as thickeners.

U.S. Pat. No. 5,015,708 describes a method of producing a terpolymer of (i) a vinyllactam, (ii) an acid-group-containing monomer and (iii) a hydrophobic monomer, which may inter alia be an ethylenically unsaturated silicone compound, by precipitation polymerization and also the production of powders from these polymers.

WO 01/62809 describes a cosmetic composition, which comprises at least one water-soluble or water-dispersible polymer which comprises, in incorporated form,

a) 5 to 50% by weight of at least one ethylenically unsaturated monomer with a tert-butyl group,
b) 25 to 90% by weight of at least one N-vinylamide and/or N-vinyllactam,
c) 0.5 to 30% by weight of at least one compound with a free-radically polymerizable, ethylenically unsaturated double bond and at least one cationogenic and/or cationic group per molecule, and
d) 0 to 30% by weight of at least one further ethylenically unsaturated compound, where the compounds may be ones with at least one anionogenic and/or anionic group per molecule.

WO 04/058837 describes an ampholytic copolymer, which is obtainable by free-radical copolymerization of

a) at least one ethylenically unsaturated compound with at least one anionogenic and/or anionic group,
b) at least one ethylenically unsaturated compound with at least one cationogenic and/or cationic group,
c) at least one unsaturated amide-group-containing compound and if appropriate further comonomers. The polymerization can take place in the presence of a graft base which may, inter alia, be a polyalkylene oxide-containing silicone derivative. Also described are polyelectrolyte complexes, which comprise one such ampholytic copolymer, and also cosmetic or pharmaceutical compositions based on these silicone-group-containing copolymers and polyelectrolyte complexes.

WO 07/012,610 describes a silicone-group-containing copolymer A) obtainable by free-radical copolymerization of

a) at least one compound with a free-radically polymerizable, ethylenically unsaturated double bond and at least one ionogenic and/or ionic group per molecule,
b) at least one free-radically polymerizable crosslinking compound, which comprises at least two unsaturated double bonds per molecule, in the presence of at least one silicone compound c), comprising a polyether group and/or a free-radically polymerizable olefinically unsaturated double bond.

WO 07/010,035 describes the use of an ampholytic copolymer, which has a molar excess of anionogenic/anionic groups compared with cationogenic/cationic groups or which has a molar excess of cationogenic/cationic groups compared with anionogenic/anionic groups and which is obtainable by free-radical copolymerization of

a1) at least one compound with one free-radically polymerizable, ethylenically unsaturated double bond and at least one anionogenic and/or anionic group per molecule,
a2) at least one compound with a free-radically polymerizable, ethylenically unsaturated double bond and at least one cationogenic and/or cationic group per molecule,
b) at least one free-radically polymerizable crosslinking compound, which comprises at least two ethylenically unsaturated double bonds per molecule,
c) if appropriate in the presence of at least one silicone compound comprising a polyether group and/or a free-radically polymerizable olefinically unsaturated double bond,
as rheology modifier for hair cosmetic compositions.

The object of the present invention is to provide novel polymers which are suitable for modifying the rheological properties of cosmetic, pharmaceutical and further compositions. In particular, these polymers should be able to be converted to a solid form, preferably a powder, which can be readily incorporated into the formulations to be thickened. Furthermore, the provided polymers should improve further application properties of the compositions modified with them, in particular their sensory properties.

In particular there is a need for polymeric thickeners for hair cosmetic compositions, which are suitable for the formulation of gel-like preparations. These should combine as many as possible of the following properties:
the resulting gels should be as clear as possible,
the resulting gels should be able to be readily distributed in the hair and impart good hold to this, which can be achieved particularly well by gels with thixotropic properties,
the resulting gels should themselves have film-forming properties and thus contribute to the setting of the hair,
the resulting gels should have conditioning properties and improve the sensory properties of the hair, e.g. impart suppleness and shine to it and, after drying, not be sticky, or be only slightly sticky,
the hair treated with the resulting gels should have good wet combability (the freshly treated hair can thus be readily shaped using the comb in order to shape the desired hairstyle),
the polymers should make it possible for gels to be able to be formulated in, as far as possible, all cosmetically acceptable pH ranges, specifically in the pH range of about 3 to 9,
the polymers should permit the formulation of gels, the properties of which are switchable via the pH,
the polymers should be able to be formulated together with thickeners, whose molecular charge carries the same sign.

Surprisingly, it has been found that these objects are achieved by polymers obtainable by precipitation polymerization of a monomer mixture which comprises

a) 30 to 99% by weight of at least one nonionic water-soluble monomer
b) at least one monomer different from a) selected from
i) monomers carrying at least one hydroxyl group,
ii) anionic monomers,
iii) mixtures of i) and ii),
   c) if appropriate a monomer carrying at least one amino group,
   d) if appropriate further monomers,
   where the total amount of a), b), c) and d) is 100% by weight and where the monomer mixture, based on the total amount of a), b), c) and d), comprises less than 0.1% by weight of a monomer with at least 2 free-radically polymerizable double bonds per molecule.

Preferred polymers according to the invention are obtainable by precipitation polymerization of a monomer mixture which comprises
a) 30 to 99% by weight of at least one nonionic water-soluble monomer
b) at least one monomer different from a) selected from
   i) monomers carrying at least one hydroxyl group,
   ii) anionic monomers,
   iii) mixtures of i) and ii), with the proviso that the monomer mixture furthermore comprises
c) at least one monomer carrying at least one amino group, if b) is selected from ii) or iii),
d) if appropriate further monomers,
   where the total amount of a), b), c) and d) is 100% by weight and where the monomer mixture, based on the total amount of a), b), c) and d), comprises less than 0.1% by weight of a monomer with at least 2 free-radically polymerizable double bonds per molecule.

Particularly preferred polymers according to the invention are obtainable by precipitation polymerization of a monomer mixture which comprises

a) 30 to 85% by weight of at least one nonionic water-soluble monomer,
b) at least one anionic monomer,
c) at least one free-radically polymerizable imidazole compound,
d) if appropriate further monomers d),
where
the total amount of a), b), c) and d) is 100% by weight and
the monomer mixture, based on the total amount of a), b), c) and d), comprises less than 0.1% by weight of a monomer with at least 2 free-radically polymerizable double bonds per molecule and
the total amount of b)+c), based on the total amount of a), b), c) and d), is in the range from 15 to 70% by weight and
the ratio of the molar amounts of b) to c) is not in the range from 1:2 to 2:1.

Within the context of the present invention, the expression alkyl comprises straight-chain and branched alkyl groups. Suitable short-chain alkyl groups are, for example, straight-chain or branched C₁-C₇-alkyl groups, preferably C₁-C₆-alkyl groups and particularly preferably C₁-C₄-alkyl groups. These include, in particular, methyl, ethyl, propyl, isopropyl, n-butyl, 2-butyl, sec-butyl, tert-butyl, n-pentyl, 1-methylbutyl, 2-methylbutyl, 3-methylbutyl, 1,2-dimethylpropyl, 1,1-dimethylpropyl, 2,2-dimethylpropyl, ethylpropyl, n-hexyl, 1-methylpentyl, 2-methylpentyl, 3-methylpentyl, 4-methylpentyl, 1,2-dimethylbutyl, 1,3-dimethylbutyl, 2,3-dimethylbutyl, 1,1-dimethylbutyl, 2,2-dimethylbutyl, 3,3-dimethylbutyl, 1,1,2-trimethylpropyl, 1,2,2-trimethylpropyl, 1-ethylbutyl, 2-ethylbutyl, 1-ethyl-2-methylpropyl, n-heptyl, 2-heptyl, 3-heptyl, 2-ethylpentyl, 1-propylbutyl, octyl, etc.

Suitable longer-chain C₈-C₃₀-alkyl or C₈-C₃₀-alkenyl groups are straight-chain and branched alkyl or alkenyl groups. These are preferably predominantly linear alkyl radicals, as also occur in natural or synthetic fatty acids and fatty alcohols and also oxo alcohols, which may, if appropriate, be additionally mono-, di- or polyunsaturated. These include, for example, n-hexyl(ene), n-heptyl(ene), n-octyl(ene), n-nonyl(ene), n-decyl(ene), n-undecyl(ene), n-dodecyl(ene), n-tridecyl(ene), n-tetradecyl(ene), n-pentadecyl(ene), n-hexadecyl(ene), n-heptadecyl(ene), n-octadecyl(ene), n-nonadecyl(ene), arachinyl(ene), behenyl(ene), lignocerinyl(ene), melissinyl(ene), etc.

Cycloalkyl is preferably C₅-C₈-cycloalkyl, such as cyclopentyl, cyclohexyl, cycloheptyl or cyclooctyl.

Aryl comprises unsubstituted and substituted aryl groups and is preferably phenyl, tolyl, xylyl, mesityl, naphthyl, fluorenyl, anthracenyl, phenanthrenyl, naphthacenyl and in particular phenyl, tolyl, xylyl or mesityl.

Within the scope of this invention, “anionic” is understood as meaning a compound which is either present in anionic form or can be converted to an anionic form by deprotonation. Examples of anionic compounds are compounds comprising COOH, COO—, or SO₃H groups.

Within the scope of this invention “cationic” is understood as meaning a compound which is either present in cationic form or can be converted to a cationic form by protonation or quaternization, in particular alkylation. Examples of cationic compounds are compounds comprising amino groups.

The polymers according to the invention can advantageously be formulated as gels under normal conditions (20° C., 1 bar). “Gel-like consistency” is shown by formulations which have a higher viscosity than a liquid and which are self-supporting, i.e. which retain a shape imparted to them without shape-stabilizing coating. In contrast to solid formulations, however, gel-like formulations can be readily deformed under the application of shear forces. The viscosity of the gel-like compositions is preferably in a range from greater than 600 to about 60 000 mPas, particularly preferably from 6000 to 30 000 mPas.

Within the context of the present invention, water-soluble monomers and polymers are understood as meaning monomers and polymers which, at 20° C., dissolve in water to give a solution which appears clear to the human eye to at least 1 g/l, preferably to at least 10 g/l. Water-dispersible monomers and polymers are understood as meaning monomers and polymers which, under the application of shear forces, for example by stirring, disintegrate into dispersible particles. Hydrophilic monomers are preferably water-soluble or at least water-dispersible. The copolymers used according to the invention are generally water-soluble.

Within the context of the present invention, “modification of rheological properties” is to be understood in the broad sense. Thus, the polymers according to the invention are generally suitable for thickening the consistency of liquid compositions within a wide range. Depending on the base consistency of the liquid compositions, flow properties from thin-liquid ranging to solid (no longer flowable) can generally be achieved depending on the amount of polymer used. “Modification of rheological properties” is therefore inter alia understood as meaning the increase in the viscosity of liquids, the improvement in the thixotropic properties of gels, the solidification of gels and waxes.

Preferred polymers according to the invention have both anionic and cationic groups. For their preparation, the oppositely charged/chargeable monomers b) and c) can be used together, i.e. in the form of a monomer pair (“monomer salt”). In this monomer composition, the molar ratio of anionic groups of component b) to cationic groups of component c) is about 1:1 (i.e. monovalent monomers are used in essentially equimolar amounts). Here, the monomer pairs can be prepared separately prior to being used for the polymerization.

### Nonionic Water-Soluble Monomer a)

Suitable monomers a) are, for example, N-vinyllactams and N-vinyllactam derivatives, which can have, for example, one or more C₁-C₆-alkyl substituents, such as methyl, ethyl, n-propyl, isopropyl, n-butyl, sec-butyl, tert-butyl. These include, for example, N-vinylpyrrolidone, N-vinylpiperidone, N-vinylcaprolactam, N-vinyl-5-methyl-2-pyrrolidone, N-vinyl-5-ethyl-2-pyrrolidone, N-vinyl-6-methyl-2-piperidone, N-vinyl-6-ethyl-2-piperidone, N-vinyl-7-methyl-2-caprolactam, N-vinyl-7-ethyl-2-caprolactam. Preferred monomers a) are N-vinylpyrrolidone and N-vinylcaprolactam.

Furthermore a) can be selected from N-vinylamides of saturated C₁-C₈-monocarboxylic acids, primary amides of α,β-ethylenically unsaturated monocarboxylic acids and the N-alkyl and N,N-dialkyl derivatives thereof, which, in addition to the carbonyl carbon atom of the amide group, have at most 8 further carbon atoms, esters of α,β-ethylenically unsaturated mono- and dicarboxylic acids with diols, amides of α,β-ethylenically unsaturated mono- and dicarboxylic acids with amino alcohols, which have a primary or secondary amino group, polyether acrylates and mixtures thereof.

N-Vinylamide compounds suitable as monomers a) are, for example, N-vinylformamide, N-vinyl-N-methylformamide, N-vinylacetamide, N-vinyl-N-methylacetamide, N-vinyl-N-ethylacetamide, N-vinylpropionamide, N-vinyl-N-methylpropionamide and N-vinylbutyramide.

Suitable monomers a) are also the monomers carrying at least one hydroxyl group specified below under monomer b) provided they are water-soluble.

Preferred monomers a) are N-vinyllactams and derivatives thereof, N-vinylamides of saturated C₁-C₈-monocarboxylic acids and (meth)acrylamides. Particularly preferred monomers a) are N-vinyllactams such as N-vinylpyrrolidone (sometimes referred to below as “NVP” or “VP”) and N-vinylcaprolactam (sometimes referred to below as “VCap”).

In a particularly preferred embodiment of the invention a) is selected from the group consisting of N-vinylpyrrolidone, N-vinylcaprolactam, (meth)acrylamide and N-vinylformamide.

### Monomer b)

Monomer b) is different from monomer a) and is selected from

i) monomers carrying at least one hydroxyl group,
ii) anionic monomers,
iii) mixtures of i) and ii).

### b) i) Monomers Carrying at Least One Hydroxyl Group

Suitable monomers b) i) are for example 2-hydroxyethyl acrylate, 2-hydroxyethyl methacrylate, 2-hydroxyethyl ethacrylate, 2-hydroxypropyl acrylate, 2-hydroxypropyl methacrylate, 3-hydroxypropyl acrylate, 3-hydroxypropyl methacrylate, 3-hydroxybutyl acrylate, 3-hydroxybutyl methacrylate, 4-hydroxybutyl acrylate, 4-hydroxybutyl methacrylate, 6-hydroxyhexyl acrylate, 6-hydroxyhexyl methacrylate, 3-hydroxy-2-ethylhexyl acrylate and 3-hydroxy-2-ethylhexyl methacrylate.

Suitable further monomers b) i) are also 2-hydroxyethylacrylamide, 2-hydroxyethylmethacrylamide, 2-hydroxyethylethacrylamide, 2-hydroxypropylacrylamide, 2-hydroxypropylmethacrylamide, 3-hydroxypropylacrylamide, 3-hydroxypropylmethacrylamide, 3-hydroxybutylacrylamide, 3-hydroxybutylmethacrylamide, 4-hydroxybutylacrylamide, 4-hydroxybutylmethacrylamide, 6-hydroxyhexylacrylamide, 6-hydroxyhexylmethacrylamide, 3-hydroxy-2-ethylhexylacrylamide and 3-hydroxy-2-ethylhexylmethacrylamide.

### b) ii) Anionic Monomers

Suitable anionic monomers b) ii) are preferably selected from monoethylenically unsaturated carboxylic acids, sulfonic acids, phosphonic acids and mixtures thereof.

b) ii) includes, in particular, monoethylenically unsaturated mono- and dicarboxylic acids having 3 to 25, preferably 3 to 6, carbon atoms, which can also be used in the form of their salts or anhydrides. Examples are acrylic acid, methacrylic acid, ethacrylic acid, α-chloroacrylic acid, crotonic acid, maleic acid, maleic anhydride, itaconic acid, citraconic acid, mesaconic acid, glutaconic acid, aconitic acid and fumaric acid. The monomers b) ii) furthermore include the half-esters of monoethylenically unsaturated dicarboxylic acids having 4 to 10, preferably 4 to 6, carbon atoms, e.g. of maleic acid such as monomethyl maleate. The monomers b) ii) also include monoethylenically unsaturated sulfonic acids and phosphonic acids, for example vinylsulfonic acid, allylsulfonic acid, sulfoethyl acrylate, sulfoethyl methacrylate, sulfopropyl acrylate, sulfopropyl methacrylate, 2-hydroxy-3-acryloxypropylsulfonic acid, 2-hydroxy-3-methacryloxypropylsulfonic acid, styrenesulfonic acid, 2-acrylamido-2-methylpropanesulfonic acid, vinylphosphonic acid and allylphosphonic acid. The monomers b) ii) also include the salts of the abovementioned acids, in particular the sodium, potassium and ammonium salts, and also the salts with amines.

The monomers b) ii) can be used as such or as mixtures with one another. The stated weight fractions all refer to the acid form.

Preferably, b) ii) is selected from acrylic acid, methacrylic acid, ethacrylic acid, α-chloroacrylic acid, crotonic acid, maleic acid, maleic anhydride, fumaric acid, itaconic acid, citraconic acid, mesaconic acid, glutaconic acid, aconitic acid and mixtures thereof.

Particularly preferably, b) ii) is or comprises (meth)acrylic acid.

To prepare the polymers according to the invention, the monomer mixture preferably comprises from 1 to 50% by weight, preferably from 3 to 40% by weight, of the anionic monomer b) ii), based on the total weight of all monomers a) to d).

### Monomer c)

Monomer c) is a monomer carrying at least one amino group and is sometimes also referred to below as cationic monomer.

In a preferred embodiment, monomer c) comprises at least one free-radically polymerizable imidazole compound and, if appropriate, further cationic monomers.

Preferred free-radically polymerizable imidazole compounds are compounds of the general formula (II)

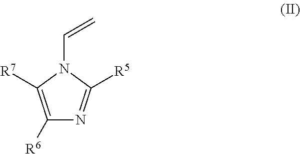

in copolymerized form, in which R⁵to R⁷, independently of one another, are hydrogen, C₁-C₄-alkyl or phenyl.

Examples of compounds of the general formula (II) are given in Table 1 below:

TABLE 1

| R5 | R6 | R7 |
|---|---|---|
| H | H | H |
| Me | H | H |
| H | Me | H |
| H | H | Me |
| Me | Me | H |
| H | Me | Me |
| Me | H | Me |
| Ph | H | H |
| H | Ph | H |
| H | H | Ph |
| Ph | Me | H |
| Ph | H | Me |
| Me | Ph | H |
| H | Ph | Me |
| H | Me | Ph |
| Me | H | Ph |

Me = methyl
Ph = phenyl

Suitable free-radically polymerizable imidazole compounds are, for example, also compounds of the formula

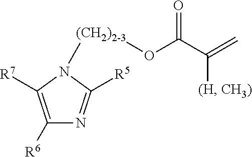

in which R⁵to R⁷, independently of one another, are hydrogen, C₁-C₄-alkyl or phenyl. Preferably, R⁵to R⁷ are hydrogen.

Suitable free-radically polymerizable imidazole compounds are also the compounds obtainable by protonation or quaternization of the abovementioned compounds. Examples of such charged monomers c) are quaternized vinylimidazoles, in particular 3-methyl-1-vinylimidazolium chloride and methosulfate. Acids or alkylating agents suitable for the protonation or quaternization, respectively, are listed below.

The preferred free-radically polymerizable imidazole compound is or comprises N-vinylimidazole.

### Further Cationic Monomers

The amino groups of the cationic monomers c) are primary, secondary and/or tertiary amino groups, and also quaternary ammonium groups. Preferably, the amino groups are tertiary amino groups or quaternary ammonium groups. Charged cationic groups can be produced from neutral amino groups by protonation or by quaternization, e.g. with acids and/or alkylating agents. Suitable acids are, for example, carboxylic acids such as lactic acid or mineral acids, such as phosphoric acid, sulfuric acid and hydrochloric acid. Suitable alkylating agents are, for example, C₁-C₄-alkyl halides or sulfates, such as ethyl chloride, ethyl bromide, methyl chloride, methyl bromide, dimethyl sulfate and diethyl sulfate. A protonation or quaternization can generally take place either before or after the polymerization.

Suitable monomers c) are furthermore the esters of α,β-ethylenically unsaturated mono- and dicarboxylic acids with amino alcohols. Preferred amino alcohols are C₂-C₁₂-amino alcohols, which are C₁-C₈-dialkylated on the amine nitrogen. Suitable acid components of these esters are for example, acrylic acid, methacrylic acid, fumaric acid, maleic acid, itaconic acid, crotonic acid, maleic anhydride, monobutyl maleate and mixtures thereof. As acid component preference is given to using acrylic acid, methacrylic acid and mixtures thereof.

Preferred monomers c) are N,N-dimethylaminomethyl (meth)acrylate, N,N-dimethylaminoethyl (meth)acrylate, N,N-diethylaminoethyl (meth)acrylate, N,N-dimethylaminopropyl (meth)acrylate, N,N-diethylaminopropyl (meth)acrylate and N,N-dimethylaminocyclohexyl (meth)acrylate.

Suitable monomers c) are furthermore the amides of the above-mentioned α,β-ethylenically unsaturated mono- and dicarboxylic acids with diamines, which have at least one primary or secondary amino group. Preference is given to diamines, which have one tertiary amino group and one primary or secondary amino group.

Suitable monomers c) are, for example, N-[2-(dimethylamino)ethyl]acrylamide, N-[2-(dimethylamino)ethyl]methacrylamide, N[3-(dimethylamino)propyl]acrylamide, N-[3-(dimethylamino)propyl]methacrylamide, N-[4-(dimethylamino)butyl]acrylamide, N[4-(dimethylamino)butyl]methacrylamide, N-[2-(diethylamino)ethyl]acrylamide, N[4-(dimethylamino)cyclohexyl]acrylamide and N-[4-(dimethylamino)cyclohexyl]methacrylamide.

Suitable monomers c) are furthermore N,N-diallylamines and N,N-diallyl-N-alkylamines and acid addition salts and quaternization products thereof. Alkyl here is preferably C₁-C₂₄-alkyl. Preference is given to N,N-diallyl-N-methylamine and N,N-diallyl-N,N-dimethylammonium compounds, such as, for example, the chlorides and bromides. These include, in particular, N,N-diallyl-N,N-dimethylammonium chloride (DADMAC).

Suitable monomers c) are furthermore various vinyl- and allyl-substituted nitrogen heterocycles such as 2- and 4-vinylpyridine, 2- and 4-allylpyridine, and the salts thereof.

The abovementioned monomers c) can in each case be used individually or in the form of any desired mixtures.

To produce the polymers according to the invention, the monomer mixture preferably comprises from 1 to 50% by weight, preferably from 3 to 40% by weight, of the cationic monomer c), based on the total weight of all monomers a) to d).

In a particularly preferred embodiment of the invention monomer c) comprises a free-radically polymerizable imidazole compound and, if appropriate, further cationic monomers.

In a preferred embodiment of the invention monomer c) comprises a free-radically polymerizable imidazole compound and an N,N-dialkylamino(meth)acrylic acid alkyl ester such as, for example, N,N-dimethylaminoethyl (meth)acrylate.

In a preferred embodiment of the invention monomer c) comprises a free-radically polymerizable imidazole compound and an N,N-dialkylamino(meth)acrylic acid alkylamide such as, for example, N[3-(dimethylamino)propyl]acrylamide.

According to the invention, the total amount of b)+c) is preferably in the range from 10 to 70% by weight, particularly preferably in the range from 20 to 50% by weight, based on the total weight of all of the monomers a) to d).

### Monomers d)

The monomers d) present if appropriate in the monomer mixture are preferably selected from

polyether (meth)acrylates, polyester (meth)acrylates,
esters of α,β-ethylenically unsaturated mono- and dicarboxylic acids with C₁-C₃₀-alkanols,
N-alkyl- and N,N-dialkylamides of α,β-ethylenically unsaturated monocarboxylic acids, which, in addition to the carbonyl carbon atom of the amide group, have at least 9 further carbon atoms,
esters of vinyl alcohol and allyl alcohol with C₁-C₃₀-monocarboxylic acids,
vinyl ethers,
vinyl aromatics,
vinyl halides,
vinylidene halides,
C₁-C₈-monoolefins,
nonaromatic hydrocarbons with at least two conjugated double bonds and mixtures thereof.

Suitable additional monomers d) are furthermore methyl (meth)acrylate, methyl ethacrylate, ethyl (meth)acrylate, ethyl ethacrylate, n-butyl (meth)acrylate, tert-butyl (meth)acrylate, tert-butyl ethacrylate, n-octyl (meth)acrylate, 1,1,3,3-tetramethylbutyl (meth)acrylate, ethylhexyl (meth)acrylate, n-nonyl (meth)acrylate, n-decyl (meth)acrylate, n-undecyl (meth)acrylate, tridecyl (meth)acrylate, myristyl (meth)acrylate, pentadecyl (meth)acrylate, palmityl (meth)acrylate, heptadecyl (meth)acrylate, nonadecyl (meth)acrylate, arrachinyl (meth)acrylate, behenyl (meth)acrylate, lignocerenyl (meth)acrylate, cerotinyl (meth)acrylate, melissinyl (meth)acrylate, palmitoleinyl (meth)acrylate, oleyl (meth)acrylate, linolyl (meth)acrylate, linolenyl (meth)acrylate, stearyl (meth)acrylate, lauryl (meth)acrylate and mixtures thereof.

Suitable additional monomers d) are furthermore N-(n-octyl)(meth)acrylamide, N-(1,1,3,3-tetramethylbutyl)(meth)acrylamide, N-ethylhexyl(meth)acrylamide, N-(n-nonyl)(meth)acrylamide, N-(n-decyl)(meth)acrylamide, N-(n-undecyl)(meth)acrylamide, N-tridecyl(meth)acrylamide, N-myristyl(meth)acrylamide, N-pentadecyl(meth)acrylamide, N-palmityl (meth)acrylamide, N-heptadecyl(meth)acrylamide, N-nonadecyl(meth)acrylamide, N-arrachinyl(meth)acrylamide, N-behenyl(meth)acrylamide, N-lignocerenyl(meth)acrylamide, N-cerotinyl(meth)acrylamide, N-melissinyl(meth)acrylamide, N-palmitoleinyl(meth)acrylamide, N-oleyl(meth)acrylamide, N-linolyl(meth)acrylamide, N-linolenyl(meth)acrylamide, N-stearyl(meth)acrylamide, N-lauryl(meth)acrylamide.

Suitable additional monomers d) are furthermore vinyl acetate, vinyl propionate, vinyl butyrate and mixtures thereof.

Suitable additional monomers d) are furthermore ethylene, propylene, isobutylene, butadiene, styrene, α-methylstyrene, acrylonitrile, methacrylonitrile, vinyl chloride, vinylidene chloride, vinyl fluoride, vinylidene fluoride and mixtures thereof.

Particularly preferred as monomers d) are polyether (meth)acrylates, which, within the context of this invention, are to be understood generally as meaning esters of α,β-ethylenically unsaturated mono- and dicarboxylic acids with polyetherols. Suitable polyetherols are linear or branched substances which comprise ether bonds and have terminal hydroxyl groups. In general, they have a molecular weight in the range from about 150 to 20 000. Suitable polyetherols are polyalkylene glycols, such as polyethylene glycols, polypropylene glycols, polytetrahydrofurans and alkylene oxide copolymers. Suitable alkylene oxides for producing alkylene oxide copolymers are, for example, ethylene oxide, propylene oxide, epichlorohydrin, 1,2- and 2,3-butylene oxide. The alkylene oxide copolymers can comprise the copolymerized alkylene oxide units in random distribution or in the form of blocks. Preference is given to ethylene oxide/propylene oxide copolymers. Preferred as component d) are polyether (meth)acrylates of the general formula

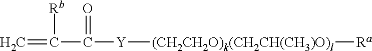

in which the order of the alkylene oxide units is arbitrary,
k and l, independently of one another, are an integer from 0 to 1000, where the sum of k and l is at least 5,
R^{a}is hydrogen, C1-C30-alkyl or C5-C8-cycloalkyl,
R^{b}is hydrogen or C1-C8-alkyl,
Y is 0 or NR^{b}, where R^{b}is hydrogen, C1-C30-alkyl or C5-C8-cycloalkyl.

Preferably, k is an integer from 1 to 500, in particular 3 to 250. Preferably, l is an integer from 0 to 100.

Preferably, R^{b}is hydrogen, methyl, ethyl, n-propyl, isopropyl, n-butyl, sec-butyl, tert-butyl, n-pentyl or n-hexyl, in particular hydrogen, methyl or ethyl.

Preferably, R^{a}is C8-C30-alkyl, in particular C12-C30-alkyl, such as decyl, undecyl, tridecyl, myristyl, pentadecyl, palmityl, lauryl, stearyl, etc.

### Preferably, Y is 0 or NH.

Suitable polyether (meth)acrylates are, for example, the polycondensation products of the abovementioned α,β-ethylenically unsaturated mono- and/or dicarboxylic acids and their acid chlorides, amides and anhydrides with polyetherols. Suitable polyetherols can be readily prepared by reacting ethylene oxide, 1,2-propylene oxide and/or epichlorohydrin with a starter molecule, such as water or a short-chain alcohol R^{a}—OH. The alkylene oxides can be used individually, alternately one after the other or as a mixture. Suitable polyether acrylates can also be produced through transesterification of the esters of α,β-ethylenically unsaturated mono- and dicarboxylic acids with polyetherols. This process generally results in product mixtures which comprise both the esters used as starting materials and also the polyether (meth)acrylates formed by transesterification. These mixtures can generally be used for producing the polymers according to the invention without prior separation. The polyether (meth)acrylates can be used on their own or in mixtures for producing the polymers according to the invention.

Preferably, the fraction of monomers d) is 0 to 15% by weight, particularly preferably 0.1 to 10% by weight, based on the total weight of the monomers a) to d) used for the polymerization.

The polymers according to the invention are preferably essentially linear, i.e. neither branched nor crosslinked. Consequently, the polymers according to the invention comprise less than 0.1% by weight, preferably less than 0.05% by weight, further preferably less than 0.01% by weight, further preferably less than 0.001% by weight and in particular less than 0.0001% by weight, of a monomer with at least 2 free-radically polymerizable double bonds per molecule in copolymerized form. Most preferably, the polymers according to the invention comprise no such monomers in copolymerized form.

The polymers according to the invention are produced by the method of precipitation polymerization.

The invention thus further provides a method for producing the polymers according to the invention, wherein the polymerization is a precipitation polymerization.

In a specific embodiment of the invention, to produce the polymers according to the invention, use is made of at least two free-radical initiators whose decomposition temperatures and/or half-lives thereof at a certain polymerization temperature are different from one another. As a result, copolymers with particularly low residual monomer contents can be achieved. This is the case, particularly if the initiator that decomposes at the higher temperature is added before the polymer has finished precipitating, preferably before the polymer has started precipitating.

During the precipitation polymerization, the monomers used are soluble in the reaction medium which comprises the monomers and the solvent, but not the resulting polymer. The resulting polymer becomes insoluble under the chosen polymerization conditions and precipitates out. In this process, it is possible to obtain copolymers with higher molecular weights than according to other polymerization processes, e.g. through solution polymerization. Such copolymers having relatively high molecular weights are particularly advantageously suitable as rheology modifiers, in particular as thickeners.

The precipitation polymerization preferably takes place in a solvent, in which each of the monomers used is soluble at 20° C. and 1 bar to give a solution that is clear to the human eye in an amount of at least 10% by weight.

The precipitation polymerization takes place, for example, in an ester such as ethyl acetate or butyl acetate and/or a hydrocarbon such as cyclohexane or n-heptane as solvent. The resulting polymer particles precipitate out of the reaction solution and can be isolated by customary methods, such as filtration by means of subatmospheric pressure.

The polymerization temperatures are preferably in a range from about 30 to 120° C., particularly preferably from 40 to 100° C. The polymerization usually takes place under atmospheric pressure, although it can also proceed under reduced or increased pressure. A suitable pressure range is between 1 and 5 bar.

Initiators that can be used for the free-radical polymerization are the peroxo and/or azo compounds customary for this purpose, for example alkali metal or ammonium peroxydisulfates, diacetyl peroxide, dibenzoyl peroxide, succinyl peroxide, di-tert-butyl peroxide, tert-butyl perbenzoate, tert-butyl perpivalate, tert-butyl peroxy-2-ethylhexanoate, tert-butyl permaleate, cumene hydroperoxide, diisopropyl peroxydicarbamate, bis(o-toluoyl) peroxide, didecanoyl peroxide, dioctanoyl peroxide, dilauroyl peroxide, tert-butyl perisobutyrate, tert-butyl peracetate, di-tert-amyl peroxide, tert-butyl hydroperoxide, azobisisobutyronitrile, azobis(2-amidinopropane) dihydrochloride or 2-2′-azobis(2-methylbutyronitrile). Also suitable are initiator mixtures or redox initiator systems, such as, for example, ascorbic acid/iron(II) sulfate/sodium peroxodisulfate, tert-butyl hydroperoxide/sodium disulfite, tert-butyl hydroperoxide/sodium hydroxymethanesulfinate, H₂O₂/Cu(I).

To adjust the molecular weight, the polymerization can take place in the presence of at least one regulator. Regulators that can be used are the customary compounds known to the person skilled in the art, such as, for example, sulfur compounds, e.g. mercaptoethanol, 2-ethylhexyl thioglycolate, thioglycolic acid or dodecyl mercaptan and also tribromochloromethane or other compounds which have a regulating effect on the molecular weight of the resulting polymers. A preferred regulator is cysteine.

To achieve the purest polymers possible with a low residual monomer content, the polymerization (main polymerization) can be followed by an afterpolymerization step. The afterpolymerization can take place in the presence of the same initiator system as the main polymerization, or of a different one. Preferably, the afterpolymerization takes place at least at the same temperature as the main polymerization, preferably at a higher temperature. The temperature during the main polymerization and the afterpolymerization is preferably at most 100° C. (main reaction) and 130° C. (afterpolymerization).

After the afterpolymerization step, the precipitated polymer is isolated from the reaction mixture, for which purpose any customary method can be used for isolating the polymers in conventional precipitation polymerization. Such methods are filtration, centrifugation, evaporation of the solvent or combinations of these methods. To further purify the polymer from nonpolymerized constituents, the polymer can be washed. For this, the same solvents can in principle be used as are suitable for the polymerization.

The preferably resulting polymer dry powders can advantageously be converted to an aqueous solution or dispersion by dissolution or redispersion, respectively, in water. Pulverulent copolymers have the advantage of better storability and easier transportability and usually exhibit a lower propensity for microbial attack.

The acid groups of the polymers can be partially or completely neutralized with a base. Bases which can be used for the neutralization of the polymers are alkali metal bases such as sodium hydroxide solution, potassium hydroxide solution, sodium carbonate, sodium hydrogencarbonate, potassium carbonate or potassium hydrogencarbonate and alkaline earth metal bases, such as calcium hydroxide, calcium oxide, magnesium hydroxide or magnesium carbonate and also amines. Suitable amines are, for example, C1-C6-alkylamines, preferably n-propylamine and n-butylamine, dialkylamines, preferably diethylpropylamine and dipropylmethylamine, trialkylamines, preferably triethylamine and triisopropylamine. Preference is given to amino alcohols, e.g. trialkanolamines, such as triethanolamine, alkyldialkanolamines, such as methyl- or ethyldiethanolamine and dialkylalkanolamines, such as dimethylethanolamine, and also 2-amino-2-methyl-1-propanol. Particularly for use in hair treatment compositions, 2-amino-2-methyl-1-propanol, 2-amino-2-ethylpropane-1,3-diol, diethylaminopropylamine and triisopropanolamine have proven particularly useful for the neutralization of the polymers comprising acid groups. The neutralization of the acid groups can also be carried out with the aid of mixtures of two or more bases, e.g. mixtures of sodium hydroxide solution and triisopropanolamine. Depending on the intended used, the neutralization can take place partially or completely.

Charged cationic groups can be produced, for example, from the amino groups either by protonation, e.g. with mono- or polybasic carboxylic acids, such as lactic acid or tartaric acid, or with mineral acids, such as phosphoric acid, sulfuric acid and hydrochloric acid, or by quaternization, e.g. with alkylating agents such as C1- to C4-alkyl halides or sulfates. Examples of such alkylating agents are ethyl chloride, ethyl bromide, methyl chloride, methyl bromide, dimethyl sulfate and diethyl sulfate.

The polymers according to the invention can be used, in particular as thickeners, in aqueous preparations in the sectors of household, personal care, building industry, textiles, for paper coating slips, pigment printing pastes, aqueous colors, leather-treatment compositions, cosmetic formulations, pharmaceutical products and agrochemicals.

The invention therefore further provides cosmetic and/or pharmaceutical preparations, which comprise the polymers according to the invention.

The invention further provides cosmetic or pharmaceutical preparations comprising

A) at least one polymer according to the invention and
B) at least one cosmetically acceptable carrier.

The preparations according to the invention preferably have a cosmetically or pharmaceutically acceptable carrier B) which is selected from
i) water,
ii) water-miscible organic solvents, preferably C₂-C₄-alkanols, in particular ethanol,
iii) oils, fats, waxes,
iv) esters of C₆-C₃₀-monocarboxylic acids with mono-, di- or trihydric alcohols, that are different from 11i),
v) saturated acyclic and cyclic hydrocarbons,
vi) fatty acids,
vii) fatty alcohols,
viii) propellant gases,
   and mixtures thereof.

The preparations according to the invention have, for example, an oil or fat component B) which is selected from: hydrocarbons of low polarity, such as mineral oils; linear saturated hydrocarbons, preferably having more than 8 carbon atoms, such as tetradecane, hexadecane, octadecane, etc.; cyclic hydrocarbons, such as decahydronaphthalene; branched hydrocarbons; animal and vegetable oils; waxes; wax esters; Vaseline; esters, preferably esters of fatty acids, such as for example the esters of C₁-C₂₄-monoalcohols with C₁-C₂₂-monocarboxylic acids, such as isopropyl isostearate, n-propyl myristate, isopropyl myristate, n-propyl palmitate, isopropyl palmitate, hexacosanyl palmitate, octacosanyl palmitate, triacontanyl palmitate, dotriacontanyl palmitate, tetratriacontanyl palmitate, hexacosanyl stearate, octacosanyl stearate, triacontanyl stearate, dotriacontanyl stearate, tetratriacontanyl stearate; salicylates, such as C₁-C₁₀-salicylates, e.g. octyl salicylate; benzoate esters, such as C10-C₁₅-alkyl benzoates, benzyl benzoate; other cosmetic esters, such as fatty acid triglycerides, propylene glycol monolaurate, polyethylene glycol monolaurate, C₁₀-C₁₅-alkyl lactates, etc. and mixtures thereof.

The oil component B) can also be selected from silicone oils, such as, for example, linear polydimethylsiloxanes, poly(methylphenyl)siloxanes, cyclic siloxanes and mixtures thereof. The number-average molecular weight of the polydimethylsiloxanes and poly(methylphenyl)siloxanes is preferably in a range from about 1000 to 150 000 g/mol. Preferred cyclic siloxanes have 4- to 8-membered rings. Suitable cyclic siloxanes are commercially available, for example, under the name Cyclomethicon.

Preferred oil or fat components B) are selected from paraffin and paraffin oils; Vaseline; natural fats and oils, such as castor oil, soya oil, peanut oil, olive oil, sunflower oil, sesame oil, avocado oil, cocoa butter, almond oil, peach kernel oil, ricinus oil, cod-liver oil, pig grease, spermaceti, spermaceti oil, sperm oil, wheat germ oil, macadamia nut oil, evening primrose oil, jojoba oil; fatty alcohols, such as lauryl alcohol, myristyl alcohol, cetyl alcohol, stearyl alcohol, oleyl alcohol, cetyl alcohol; fatty acids, such as myristic acid, stearic acid, palmitic acid, oleic acid, linoleic acid, linolenic acid and saturated, unsaturated and substituted fatty acids different therefrom; waxes, such as beeswax, carnauba wax, candililla wax, spermaceti, and mixtures of the abovementioned oil or fat components.

Suitable cosmetically and pharmaceutically compatible oil and fat components B) are also described in Karl-Heinz Schrader, Grundlagen and Rezepturen der Kosmetika [Fundamentals and formulations of cosmetics], 2nd edition, Verlag Hëthig, Heidelberg, pp. 319-355, to which reference is made here.

Advantageously, those oils, fats and/or waxes are selected which are described on page 28, line 39 to page 34, line 22 of WO 2006/106140. Reference is hereby made to the content of the specified passage in its entirety.

The content of further oils, fats and waxes is at most 50% by weight, preferably 30% by weight, further preferably at most 20% by weight, based on the total weight of the composition.

Suitable hydrophilic carriers B) are selected, for example, from water, mono-, di- or polyhydric alcohols having preferably 1 to 8 carbon atoms, such as ethanol, n-propanol, isopropanol, propylene glycol, glycerol, sorbitol.

The cosmetic preparations according to the invention can be skin cosmetic, hair cosmetic, dermatological, hygiene or pharmaceutical preparations. On account of their properties, the polymers according to the invention are suitable in particular as thickeners for hair and skin cosmetics.

Preferably, the preparations according to the invention are in the form of a gel, foam, spray, ointment, cream, emulsion, suspension, lotion, milk or paste. If desired, liposomes or microspheres can also be used.

The cosmetically or pharmaceutically active preparations according to the invention can additionally comprise cosmetically and/or dermatologically active ingredients and also auxiliaries.

Preferably, the cosmetic preparations according to the invention comprise at least one polymer A), according to the invention, at least one carrier B) as defined above and at least one constituent different therefrom which is selected from cosmetically active ingredients, emulsifiers, surfactants, preservatives, perfume oils, further thickeners, hair polymers, hair and skin conditioners, graft polymers, water-soluble or dispersible silicone-containing polymers, photoprotective agents, bleaches, gel formers, care agents, colorants, tinting agents, tanning agents, dyes, pigments, consistency regulators, humectants, refatting agents, collagen, protein hydrolyzates, lipids, antioxidants, antifoams, antistats, emollients and softeners.

The cosmetic preparations according to the invention can be present as aqueous or aqueous-alcoholic solutions, 0/W and W/O emulsions, hydrodispersion formulations, solids-stabilized formulations, stick formulations, PIT formulations, in the form of creams, foams, sprays (pump spray or aerosol), gels, gel sprays, lotions, oils, oil gels or mousse and accordingly can be formulated with customary further auxiliaries.

Particularly preferred cosmetic preparations within the context of the present invention are gels, shampoos, washing and bathing preparations and also hair care compositions. The invention accordingly also provides preparations for the cleaning and/or care of the hair and of the skin.

In particular, the invention relates to hair care compositions selected from the group consisting of styling gels, shampoos, hair conditioners, hair balms, pomades, styling creams, styling lotions, styling gels, end fluids, hot-oil treatments.

Furthermore, the invention relates to cosmetic preparations which are selected from gels, gel creams, hydroformulations, stick formulations, cosmetic oils and oil gels, mascara, self-tanning compositions, face care compositions, body care compositions, after-sun preparations.

Further cosmetic preparations according to the invention are skin cosmetic preparations, in particular those for skin care. These are present in particular as W/O or O/W skin creams, day and night creams, eye creams, face creams, anti-wrinkle creams, mimic creams, moisturizing creams, bleaching creams, vitamin creams, skin lotions, care lotions and moisturizing lotions.

Furthermore, the polymers according to the invention are suitable as thickeners for skin cosmetic preparations, face masks, cosmetic lotions and for use in decorative cosmetics, for example for concealing sticks, stage make-up, in mascara and eyeshadow, lipsticks, kohl pencils, eyeliners, make-up, foundations, blushers and powders and eyebrow pencils.

Furthermore, the preparations according to the invention can be used in anti-acne compositions, repellents, shaving compositions, hair-removal compositions, intimate care compositions, foot care compositions, and also in baby care.

Further preferred preparations according to the invention are washing, showering and bathing preparations which comprise the polymers according to the invention. Within the context of this invention, washing, showering and bathing preparations are understood as meaning soaps of liquid to gel-like consistency, such as transparent soaps, luxury soaps, deodorant soaps, cream soaps, baby soaps, skin protection soaps, abrasive soaps and syndets, pasty soaps, soft soaps and washing pastes, liquid washing, showering and bathing preparations, such as washing lotions, shower baths, shower gels, foam baths, oil baths and scrub preparations, shaving foams, shaving lotions and shaving creams.

Suitable further ingredients for these washing, showering and bathing preparations according to the invention are described below.

Besides the polymers A) according to the invention and the carrier B), the preparations according to the invention preferably comprise further cosmetically acceptable additives, such as, for example, emulsifiers and coemulsifiers, solvents, surfactants, oil bodies, preservatives, perfume oils, cosmetic care and active ingredients such as AHA acids, fruit acids, ceramides, phytantriol, collagen, vitamins and provitamins, for example, vitamins A, E and C, retinol, bisabolol, panthenol, natural and synthetic photoprotective agents, natural substances, opacifiers, solubility promoters, repellents, bleaches, colorants, tinting agents, tanning agents (e.g. dihydroxyacetone), micropigments such as titanium oxide or zinc oxide, superfatting agents, pearlescent waxes, consistency regulators, further thickeners, solubilizers, complexing agents, fats, waxes, silicone compounds, hydrotropes, dyes, stabilizers, pH regulators, reflectors, proteins and protein hydrolyzates (e.g. wheat, almond or pea proteins), ceramide, protein hydrolyzates, salts, gel formers, consistency regulators, silicones, humectants (e.g. 1,2-pentanediol), refatting agents, UV photoprotective filters and further customary additives. Furthermore, to establish the properties desired in each case, it is in particular also possible for further polymers to be present.

The cosmetic preparations according to the invention comprise the polymers according to the invention in an amount of from 0.01 to 10% by weight, preferably from 0.05 to 5% by weight, particularly preferably 0.1 to 1.5% by weight, based on the weight of the preparation.

In one preferred embodiment of the invention, inventive shower gels, washing, showering and bathing preparations and also shampoos and hair care compositions furthermore comprise at least one surfactant.

In a further preferred embodiment of the invention, shampoos and hair care compositions according to the invention comprise, besides the polymers, furthermore at least one oil and/or fatty phase and a surfactant.

### Surfactants

Surfactants which can be used are anionic, cationic, nonionic and/or amphoteric surfactants.

Advantageous washing-active anionic surfactants within the context of the present invention are
acylamino acids and salts thereof, such as acyl glutamates, in particular sodium acyl glutamate
sarcosinates, for example myristoyl sarcosine, TEA-lauroyl sarcosinate, sodium lauroyl sarcosinate and sodium cocoyl sarcosinate, sulfonic acids and salts thereof, such as
acyl isethionates, for example sodium or ammonium cocoyl isethionate
sulfosuccinates, for example dioctyl sodium sulfosuccinate, disodium laureth sulfosuccinate, disodium lauryl sulfosuccinate and disodium undecylenamido MEA sulfosuccinate, disodium PEG-5 lauryl citrate sulfosuccinate and derivatives,
alkyl ether sulfates, for example sodium, ammonium, magnesium, MIPA, TIPA laureth sulfate, sodium myreth sulfate and sodium C₁₂₋₁₃ parethsulfate,
alkyl ether sulfonates, for example sodium C12-15 pareth-15 sulfonate
alkyl sulfates, for example sodium, ammonium and TEA lauryl sulfate.

Further advantageous anionic surfactants are
taurates, for example sodium lauroyl taurate and sodium methyl cocoyl taurate,
ether carboxylic acids, for example sodium laureth-13 carboxylate and sodium PEG-6 cocamide carboxylate, sodium PEG-7 olive oil carboxylate
phosphoric acid esters and salts, such as, for example, DEA-oleth-10 phosphate and dilaureth-4 phosphate,
alkyl sulfonates, for example sodium coconut monoglyceride sulfate, sodium C₁₂₋₁₄ olefinsulfonate, sodium lauryl sulfoacetate and magnesium PEG-3 cocamide sulfate,
acyl glutamates such as di-TEA palmitoyl aspartate and sodium caprylic/capric glutamate,
acyl peptides, for example palmitoyl hydrolyzed milk protein, sodium cocoyl hydrolyzed soya protein and sodium/potassium cocoyl hydrolyzed collagen and also carboxylic acids and derivatives, such as, for example, lauric acid, aluminum stearate, magnesium alkanolate and zinc undecylenate, ester carboxylic acids, for example, calcium stearoyl lactylate, laureth-6 citrate and sodium PEG-4 lauramide carboxylate
alkylarylsulfonates.

Advantageous washing-active cationic surfactants within the context of the present invention are quaternary surfactants. Quaternary surfactants comprise at least one N atom, which is covalently bonded to 4 alkyl or aryl groups. For example, alkylbetaine, alkylamidopropylbetaine and alkylamidopropylhydroxysultaine are advantageous. Further advantageous cationic surfactants within the context of the present invention are also
alkylamines,
alkylimidazoles and
ethoxylated amines
   and in particular salts thereof.

Advantageous washing-active amphoteric surfactants within the context of the present invention are acyl/dialkylethylenediamines, for example sodium acyl amphoacetate, disodium acyl amphodipropionate, disodium alkylamphodiacetate, sodium acyl amphohydroxypropylsulfonate, disodium acyl amphodiacetate, sodium acyl amphopropionate, and N-coconut fatty acid amidoethyl N-hydroxyethylglycinate sodium salts.

Further advantageous amphoteric surfactants are N-alkylamino acids, for example aminopropylalkylglutamide, alkylaminopropionic acid, sodium alkylimidodipropionate and lauroamphocarboxyglycinate.

Advantageous washing-active nonionic surfactants within the context of the present invention are
alkanolamides, such as cocamides MEA/DEA/MIPA,
esters, which are formed by esterification of carboxylic acids with ethylene oxide, glycerol, sorbitan or other alcohols,
ethers, for example ethoxylated alcohols, ethoxylated lanolin, ethoxylated polysiloxanes, propoxylated POE ethers, alkyl polyglycosides, such as lauryl glucoside, decyl glycoside and cocoglycoside, glycosides with an HLB value of at least 20 (e.g. Belsil®SPG 128V (Wacker)).

Further advantageous nonionic surfactants are alcohols and amine oxides, such as cocoamidopropylamine oxide.

Preferred anionic, amphoteric and nonionic shampoo surfactants are specified, for example, in “Kosmetik and Hygiene von Kopf bis Fuβ” [“Cosmetics and hygiene from head to toe”], ed. W. Umbach, 3rd edition, Wiley-VCH, 2004, pp. 131-134, to which reference is made at this point in its entirety.

Among the alkyl ether sulfates, sodium alkyl ether sulfates based on di- or triethoxylated lauryl and myristyl alcohol in particular are preferred. They are markedly superior to the alkyl sulfates with regard to insensitivity toward water hardness, ability to be thickened, low-temperature solubility and, in particular, skin and mucosa compatibility. They can also be used as sole washing raw materials for shampoos. Lauryl ether sulfate has better foam properties than myristyl ether sulfate, but is inferior to this as regards mildness.

Alkyl ether carboxylates with average and particularly with relatively high degree of ethoxylation belong to the mildest surfactants overall, but exhibit poor foaming and viscosity behavior. They are often used in combination with alkyl ether sulfates and amphoteric surfactants in hair washing compositions.

Sulfosuccinic acid esters (sulfosuccinates) are mild and readily foaming surfactants but, on account of their poor ability to be thickened, are preferably only used together with other anionic and amphoteric surfactants and, on account of their low hydrolysis stability, preferably are only used in neutral and well-buffered products. Amidopropylbetaines as sole washing raw materials are insignificant in practice, since their foaming behavior and also their ability to be thickened are only moderate. On the other hand, these surfactants have excellent skin and eye mucosa compatibility. In combination with anionic surfactants, their mildness can be synergistically improved. Preference is given to the use of cocamidopropylbetaine.

Amphoacetates/amphodiacetates have, as amphoteric surfactants, very good skin and mucosa compatibility and can have a hair-conditioning effect and/or increase the care effect of additives. Similarly to the betaines, they are used for the optimization of alkyl ether sulfate formulations. Sodium cocoamphoacetate and disodium cocoamphodiacetate are most preferred.

Alkyl polyglycosides are nonionic washing raw materials. They are mild, have good universal properties, but are weakly foaming. For this reason, they are preferably used in combinations with anionic surfactants.

Sorbitan esters are likewise types of nonionic washing raw materials. On account of their excellent mildness, they are preferably employed for use in baby shampoos. Being weak foamers, they are preferably used in combination with anionic surfactants. It is advantageous to select the washing-active surfactant or surfactants from the group of surfactants which have an HLB value of more than 25, those which have an HLB value of more than 35 being particularly advantageous.

According to the invention, it is advantageous if one or more of these surfactants is used in a concentration of from 1 to 30% by weight, preferably in a concentration of from 5 to 25% by weight and very particularly preferably in a concentration of from 10 to 20% by weight, in each case based on the total weight of the preparation.

### Polysorbates

As washing-active agents, polysorbates can also advantageously be incorporated into the preparations according to the invention.

Polysorbates advantageous within the context of the invention are, for example,
polyoxyethylene(20) sorbitan monolaurate (Tween®20, CAS No. 9005-64-5)
polyoxyethylene(4) sorbitan monolaurate (Tween®21, CAS No. 9005-64-5)
polyoxyethylene(4) sorbitan monostearate (Tween®61, CAS No. 9005-67-8)
polyoxyethylene(20) sorbitan tristearate (Tween®65, CAS No. 9005-71-4)
polyoxyethylene(20) sorbitan monooleate (Tween®80, CAS No. 9005-65-6)
polyoxyethylene(5) sorbitan monooleate (Tween®81, CAS No. 9005-65-5)
polyoxyethylene(20) sorbitan trioleate (Tween®85, CAS No. 9005-70-3).
Polyoxyethylene(20) sorbitan monopalmitate (Tween®40, CAS No. 9005-66-7) and
polyoxyethylene(20) sorbitan monostearate (Tween®60, CAS No. 9005-67-8) are particularly advantageous.

The polysorbates are advantageously used in a concentration of from 0.1 to 5% by weight and in particular in a concentration of from 1.5 to 2.5% by weight, based on the total weight of the preparation, individually or as a mixture of two or more polysorbates.

### Conditioners

The conditioners selected for the cosmetic preparations according to the invention are preferably those which are described on page 34, line 24 to page 37, line 10 of WO 2006/106140. Reference is hereby made to the content of the specified passage in its entirety.

### Rheology Modifiers

In general, the rheology of the preparations according to the invention can be adjusted to the desired value by adding the polymers according to the invention. However, it is of course possible to additionally use further thickeners in the preparations according to the invention. Thickeners suitable for gels, shampoos and hair care compositions are specified in “Kosmetik and Hygiene von Kopf bis Fuβ” [“Cosmetics and hygiene from head to toe”], ed. W. Umbach, 3rd edition, Wiley-VCH, 2004, pp. 235-236, to which reference is made at this point in its entirety.

Suitable further thickeners for the cosmetic preparations according to the invention are described, for example, also on page 37, line 12 to page 38, line 8 of WO 2006/106140. Reference is hereby made to the content of the specified passage in its entirety.

### Preservatives

Compositions with high water contents have to be reliably protected against the build-up of germs. The cosmetic preparations according to the invention preferably also comprise preservatives. Suitable preservatives for the cosmetic compositions according to the invention are described, for example, on page 38, line 10 to page 39, line 18 of WO 2006/106140. Reference is hereby made to the content of the specified passage in its entirety.

Complexing agents: since the raw materials and also many cosmetic compositions are themselves manufactured predominantly in steel apparatuses, the end products can comprise iron (ions) in trace amounts. In order to prevent these impurities from adversely affecting the product quality through reactions with dyes and perfume oil constituents, complexing agents such as salts of ethylenediaminetetraacetic acid, of nitrilotriacetic acid, of iminodisuccinic acid or phosphates are added.

UV photoprotective filters: in order to stabilize the ingredients present in the compositions according to the invention, such as, for example, dyes and perfume oils against changes due to UV light, UV photoprotective filters, such as, for example, benzophenone derivatives, can be incorporated. Suitable UV photoprotective filters for the cosmetic compositions according to the invention are described, for example, on page 39, line 20 to page 41, line 10 of WO 2006/106140. Reference is hereby made to the content of the specified passage in its entirety.

Antioxidants: A content of antioxidants in the compositions according to the invention is generally preferred. According to the invention, antioxidants which can be used are all antioxidants customary or suitable for cosmetic applications. Suitable antioxidants for the cosmetic compositions according to the invention are described, for example, on page 41, line 12 to page 42, line 33 of WO 2006/106140. Reference is hereby made to the content of the specified passage in its entirety.

Buffers: buffers ensure the pH stability of the compositions. Citrate, lactate and phosphate buffers are primarily used.

Solubility promoters: These are used in order to dissolve care oils or perfume oils to give clear solutions and also to keep them in clear solutions at low temperature. The most common solubility promoters are ethoxylated nonionic surfactants, e.g. hydrogenated and ethoxylated castor oils.

Antimicrobial agents: furthermore, antimicrobial agents can also be used. These include in general all suitable preservatives with specific action against Gram-positive bacteria, e.g. triclosan (2,4,4′-trichloro-2′-hydroxydiphenyl ether), chlorhexidine (1,1′-hexamethylenebis[5-(4-chlorophenyl)biguanide) and TTC (3,4,4′-trichlorocarbanilide). Quaternary ammonium compounds are in principle likewise suitable and are preferably used for disinfectant soaps and washing lotions. Numerous fragrances also have antimicrobial properties. A large number of essential oils and their characteristic ingredients, such as, for example, clove oil (eugenol), mint oil (menthol) or thyme oil (thymol), also exhibit marked antimicrobial effectiveness.

The antibacterially effective substances are generally used in concentrations of from about 0.1 to 0.3% by weight.

Dispersants: If insoluble active ingredients, e.g. antidandruff active ingredients or silicone oils, are to be dispersed or kept permanently in suspension in the compositions according to the invention, dispersants and thickeners, such as, for example, magnesium-aluminum silicates, bentonites, fatty acyl derivatives, polyvinylpyrrolidone or hydrocolloids, e.g. xanthan gum or carbomers, have to be used.

According to the invention, preservatives are present in a total concentration of at most 2% by weight, preferably at most 1.5% by weight and particularly preferably at most 1% by weight, based on the total weight of the composition.

Apart from the abovementioned substances, the compositions can, if appropriate, comprise the additives customary in cosmetics, for example perfume, dyes, refatting agents, complexing and sequestering agents, pearlizing agents, plant extracts, vitamins, active ingredients, pigments which have a coloring effect, softening, moisturizing and/or humectant substances, or other customary constituents of a cosmetic or dermatological formulation such as alcohols, polyols, polymers, organic acids for adjusting the pH, foam stabilizers, electrolytes, organic solvents or silicone derivatives.

With regard to the specified further ingredients known to the person skilled in the art for the compositions, reference may be made to “Kosmetik and Hygiene von Kopf bis Fuβ” [“Cosmetics and hygiene from head to toe”], ed. W. Umbach, 3rd edition, Wiley-VCH, 2004, pp. 123-128, to which reference is made at this point in its entirety.

The compositions according to the invention, such as gels, shampoos and hair care compositions comprise, if appropriate, ethoxylated oils selected from the group of ethoxylated glycerol fatty acid esters, particular preferably PEG-10 olive oil glycerides, PEG-11 avocado oil glycerides, PEG-11 cocoa butter glycerides, PEG-13 sunflower oil glycerides, PEG-15 glyceryl isostearate, PEG-9 coconut fatty acid glycerides, PEG-54 hydrogenated castor oil, PEG-7 hydrogenated castor oil, PEG-60 hydrogenated castor oil, jojoba oil ethoxylate (PEG-26 jojoba fatty acids, PEG-26 jojoba alcohol), glycereth-5 cocoate, PEG-9 coconut fatty acid glycerides, PEG-7 glyceryl cocoate, PEG-45 palm kernel oil glycerides, PEG-35 castor oil, olive oil PEG-7 ester, PEG-6 caprylic/capric glycerides, PEG-10 olive oil glycerides, PEG-13 sunflower oil glycerides, PEG-7 hydrogenated castor oil, hydrogenated palm kernel oil glyceride PEG-6 ester, PEG-20 corn oil glycerides, PEG-18 glyceryl oleate cocoate, PEG-40 hydrogenated castor oil, PEG-40 castor oil, PEG-60 hydrogenated castor oil, PEG-60 corn oil glycerides, PEG-54 hydrogenated castor oil, PEG-45 palm kernel oil glycerides, PEG-80 glyceryl cocoate, PEG-60 almond oil glycerides, PEG-60 evening primrose glycerides, PEG-200 hydrogenated glyceryl palmate, PEG-90 glyceryl isostearate.

Preferred ethoxylated oils are PEG-7 glyceryl cocoate, PEG-9 coconut glycerides, PEG-40 hydrogenated castor oil, PEG-200 hydrogenated glyceryl palmate. Ethoxylated glycerol fatty acid esters are used in aqueous cleaning formulations for various purposes. Glycerol fatty acid esters with a degree of ethoxylation of about 30-50 serve as solubility promoters for nonpolar substances such as perfume oils. Highly ethoxylated glycerol fatty acid esters are used as thickeners.

### Active Ingredients

Active ingredients of varying solubility can be homogeneously incorporated into the compositions according to the invention. Advantageous active ingredients in the cosmetic compositions according to the invention are described, for example, on page 44, line 24 to page 49, line 39 of WO 2006/106140. Reference is hereby made to the content of the specified passage in its entirety.

UV Photoprotective Agents

In a preferred embodiment, the compositions according to the invention comprise UV photoprotective agents to protect the skin and/or the hair. Suitable UV photoprotective agents are described in detail in WO 2006/106114, p. 24, l. 4 to p. 27, l. 27, to which reference is hereby made in its entirety.

Advantageously, the compositions comprise substances which absorb UV radiation in the UVB region and substances which absorb UV radiation in the UVA region, where the total amount of the filter substances is, for example, 0.1 to 30% by weight, preferably 0.5 to 20% by weight, in particular 1 to 15% by weight, based on the total weight of the compositions, in order to provide cosmetic compositions which protect the skin from the entire range of ultraviolet radiation.

The majority of the photoprotective agents in the cosmetic or dermatological compositions serving to protect the human epidermis consists of compounds which absorb UV light in the UV-B region. For example, the fraction of the UV-A absorbers to be used according to the invention is 10 to 90% by weight, preferably 20 to 50% by weight, based on the total amount of substances absorbing UV-B and UV-A.

### Pearlescent Waxes

Suitable pearlescent waxes for the cosmetic compositions according to the invention are described, for example, on page 50, line 1 to line 16 of WO 2006/106140. Reference is hereby made to the content of the specified passage in its entirety. The compositions according to the invention can furthermore comprise glitter substances and/or other effect substances (e.g. color streaks).

### Emulsifiers

In one preferred embodiment of the invention, the cosmetic compositions according to the invention are in the form of emulsions. The preparation of such emulsions takes place by known methods. Suitable emulsifiers for the emulsions according to the invention are described, for example, on page 50, line 18 to page 53, line 4 of WO 2006/106140. Reference is hereby made to the content of the specified passage in its entirety.

### Perfume Oils

If perfume oils are to be added to the cosmetic compositions according to the invention, then suitable perfume oils are described, for example, on page 53, line 10 to page 54, line 3 of WO 2006/106140. Reference is hereby made to the content of the specified passage in its entirety.

### Pigments

If appropriate, the cosmetic compositions according to the invention furthermore comprise pigments. The pigments are present in the product mostly in undissolved form and may be present in an amount of from 0.01 to 25% by weight, particularly preferably from 0.5 to 15% by weight. The preferred particle size is 0.01 to 200 μm, in particular 0.02 to 150 μm, particularly preferably 0.05 to 100 μm. Suitable pigments for the compositions according to the invention are described, for example, on page 54, line 5 to page 55, line 19 of WO 2006/106140. Reference is hereby made to the content of the specified passage in its entirety.

### Nanoparticles

If appropriate, the compositions according to the invention comprise water-insoluble nanoparticles, i.e. particles with a particle size in the range from 1 to 200, preferably from 5 to 100 nm. Preferred nanoparticles are nanoparticles of metal oxides, in particular of zinc oxide and/or titanium dioxide.

### Polymers

In one preferred embodiment, apart from the polymers according to the invention, the cosmetic compositions according to the invention also comprise further polymers. Preferred further polymers are water-soluble or water-dispersible polymers, with water-soluble polymers being particularly preferred.

Further polymers suitable for the compositions according to the invention are described, for example, on page 55, line 21 to page 63, line 2 of WO 2006/106140. Reference is hereby made to the content of the specified passage in its entirety.

### Shampoo Types

A preferred embodiment of the invention is hair shampoos comprising the polymers according to the invention. Additional requirements are, if appropriate, placed on shampoos according to hair quality or scalp problem. The mode of action of the preferred shampoo types with the most important additional effects or most important special objectives is described below.

According to the invention, preference is given, for example, to shampoos for normal or greasy or damaged hair, antidandruff shampoos, baby shampoos and 2-in-1 shampoos (i.e. shampoo and conditioner in one).

Shampoos according to the invention for normal hair: hair washing should free hair and scalp from the sebum formed in sebaceous glands, the inorganic salts emerging from sweat glands with water, amino acids, urea and lactic acid, shed skin particles, environmental dirt, odors, and, if appropriate, residues of hair cosmetic treatments. Normal hair means short to shoulder-length hair which is only slightly damaged. Accordingly, the fraction of conditioning auxiliaries should be optimized to this hair type. Shampoos according to the invention for greasy hair: increased sebum production by the sebaceous glands of the scalp leads just 1-2 days after hair washing to a straggly, unkempt hairstyle. Oil- and wax-like skin sebum constituents weigh down the hair and reduce the friction from hair to hair and thus reduce the style hold. The actual hair cosmetic problem in the case of greasy hair is thus the premature collapse of voluminous hairstyles. In order to avoid this, it is necessary to prevent the hair surface from becoming weighed down and too smooth and supple. This is preferably achieved through the surfactant base of washing raw materials that clean well and are marked by particularly low substantivity. Additional care substances, which would add to the skin sebum, such as refatting substances, are used in shampoos for greasy hair only with the greatest of care, if at all. Volumizing shampoos for fine hair according to the invention can be formulated comparably.

Shampoos according to the invention for dry, stressed (damaged) hair: the structure of the hair is changed in the course of hair growth by mechanical influences such as combing, brushing and primarily back-combing (combing against the direction of growth), by the effect of UV radiation and visible light and by cosmetic treatments, such as permanent waves, bleaching or coloring. The flake layer of the hair has an increasingly stressed appearance from the root to the end; in extreme cases, it is completely worn away at the end and the hair ends are split (split ends). Damaged hair can in principle no longer be returned to the state of healthy hair regrowth. However, it is possible to come very close to this ideal state as regards feel, shine and combability through using shampoos according to the invention, with, if appropriate, high fractions of care substances (conditioners).

An even better hair conditioning effect than with a shampoo is achieved with a hair care composition according to the invention, for example, in the form of a rinse or cure treatment after hair washing. Rinses or cures for hair which comprise polymers according to the invention are likewise in accordance with the invention.

2-in-1 shampoos according to the invention are particularly high-care shampoos, in which, as a result of the design as “shampoo and conditioner in one”, the additional care benefit is placed equally alongside the basic cleaning benefit. 2-in-1 compositions according to the invention comprise increased amounts of conditioners.

Antidandruff shampoos: compared to antidandruff hair tonics, antidandruff shampoos according to the invention have the advantage that they not only reduce the formation of new visible flakes through appropriate active ingredients against dandruff attack and prevent such formation upon long-term application, but also remove flakes already shed with the hair washing. However, after rinsing out the wash liquor, only a small, but adequate amount of the active ingredients remains on scalp and hair. There are various antidandruff active ingredients which can be incorporated into the shampoo compositions according to the invention, such as, for example, zinc pyrithione, ketoconazole, elubiole, clotrimazole, climbazole or piroctone olamine. Additionally, these substances have a normalizing effect on shedding.

The basis of antidandruff shampoos corresponds primarily to the formulation of shampoos for normal hair with a good cleaning effect.

Baby shampoos: in a preferred embodiment of the invention, the shampoo preparations according to the invention are baby shampoos. These are optimally skin- and mucosa-compatible. Combinations of washing raw materials with very good skin compatibility form the basis of these shampoos. Additional substances for further improving the skin and mucosa compatibility and the care properties are advantageously added, such as, for example, nonionic surfactants, protein hydrolyzates and panthenol or bisabolol. All of the required raw materials and auxiliaries, such as preservatives, perfume oils, dyes etc., are selected from the aspect of high compatibility and mildness.

Shampoos for dry scalp: in a further preferred embodiment of the invention, the shampoo preparations according to the invention are shampoos for dry scalp. The primary aim of these shampoos is to prevent the scalp from drying out since a dry scalp can lead to itchiness, reddening and inflammation. As also in the case of the baby shampoos, combinations of washing raw materials with very good skin compatibility form the basis of these shampoos. Additionally, if appropriate, refatting agents and humectants, such as, for example, glycerol or urea, can be used.

The shampoo compositions according to the invention can also be in the form of shampoo concentrates with increased surfactant contents of 20-30% by weight. They are based on special washing raw material combinations and consistency regulators, which ensure good spreadability and the spontaneous foaming ability even of a small application amount. A particular advantage is, for example, the possibility of achieving the productivity of 200 ml of shampoo with a 100 ml bottle.

### Supply Form

It is advantageous if the compositions according to the invention are stored in a bottle or squeezable bottle and are applied from this. Accordingly, bottles or squeezable bottles which comprise a composition according to the invention are also in accordance with the invention.

The polymers according to the invention, as defined above, can preferably be used in shampoo formulations in particular as conditioners. Preferred shampoo formulations comprise

a) 0.05 to 10% by weight of at least one polymer according to the invention,
b) 25 to 94.95% by weight of water,
c) 5 to 50% by weight of surfactants,
d) 0 to 5% by weight of a conditioner,
e) 0 to 10% by weight of further cosmetic constituents.

All anionic, neutral, amphoteric or cationic surfactants customarily used in shampoos can be used in the shampoo formulations. Suitable surfactants have been specified above.

To achieve certain effects, customary conditioners can be used in combination with the polymers according to the invention in the shampoo formulations. These include, for example, cationic polymers with the INCI name Polyquaternium, in particular copolymers of vinylpyrrolidone/N-vinylimidazolium salts (Luviquat®FC, Luviquat®HM, Luviquat®MS, Luviquat®Care), copolymers of N-vinylpyrrolidone/dimethylaminoethyl methacrylate, quaternized with diethyl sulfate (Luviquat®PQ 11), copolymers of N-vinylcaprolactam/N-vinylpyrrolidone/N-vinylimidazolium salts (Luviquat®Hold); cationic cellulose derivatives (Polyquaternium-4 and -10), acrylamide copolymers (Polyquaternium-7).

Advantageous conditioners are, for example, the compounds referred to in accordance with INCI as Polyquaternium (in particular Polyquaternium-1 to Polyquaternium-87). The following table gives a non-exhaustive overview of conditioners which are used in combination with the polymers according to the invention:

| | | | Example |
|---|---|---|---|
| INCI name | CAS Number | Polymer type | (trade name) |
| Polyquaternium-2 | CAS 63451-27-4 | Urea, N,N′, bis[3- | Mirapol ® A-15 |
| | | (dimethylamino)propyl] polymer with | |
| | | 1,1′-oxybis(2-chloroethane) | |
| Polyquaternium-5 | CAS 26006-22-4 | Acrylamide, β- | |
| | | methacryloxyethyltriethylammonium | |
| | | methosulfate | |
| Polyquaternium-6 | CAS 26062-79-3 | N,N-dimethyl-N-2-propenyl-2- | Merquat ® 100 |
| | | propenaminium chloride | |
| | | (PolyDADMAC) | |
| Polyquaternium-7 | CAS 26590-05-6 | N,N-dimethyl-N-2-propenyl-2- | Merquat ® S |
| | | propenaminium chloride, | |
| | | 2-propenamide | |
| Polyquaternium-10 | CAS 53568-66-4, | Quaternary ammonium salt of | Celquat ® SC-230M, |
| | 55353-19-0, | hydroxyethylcellulose | Polymer JR 400 |
| | 54351-50-7, | | |
| | 68610-92-4, | | |
| | 81859-24-7 | | |
| Polyquaternium-11 | CAS 53633-54-8 | Vinylpyrrolidone/dimethylaminoethyl | Gafquat ® 755N |
| | | methacrylate copolymer/diethyl | |
| | | sulfate reaction product | |
| Polyquaternium-16 | CAS 29297-55-0 | Vinylpyrrolidone/vinylimidazolinium | Luviquat ® HM552 |
| | | methochloride copolymer | |
| Polyquaternium-17 | CAS 90624-75-2 | | Mirapol ® AD-1 |
| Polyquaternium-19 | CAS 110736-85-1 | Quaternized water-soluble polyvinyl | |
| | | alcohol | |
| Polyquaternium-20 | CAS 110736-86-2 | Quaternized polyvinyl octadecyl | |
| | | ether dispersible in water | |
| Polyquaternium-21 | | Polysiloxane | Abil ® B 9905 |
| | | polydimethyldimethylammonium | |
| | | acetate copolymer | |
| Polyquaternium-22 | CAS 53694-17-0 | Dimethyldiallylammonium | Merquat ® 280 |
| | | chloride/acrylic acid copolymer | |
| Polyquaternium-24 | CAS 107897-23-5 | Polymeric quaternary ammonium | Quartisoft ® LM-200 |
| | | salt of hydroxyethylcellulose | |
| Polyquaternium-28 | CAS 131954-48-8 | Vinylpyrrolidone/methacrylamido- | Gafquat ® HS-100 |
| | | propyltrimethylammonium chloride | |
| | | copolymer | |
| Polyquaternium-29 | CAS 92091-36-6, | Chitosan, which has been reacted | Lexquat ® CH |
| | 148880-30-2 | with propylene oxide and | |
| | | quaternized with epichlorohydrin | |
| Polyquaternium-31 | CAS 136505-02-7, | Polymeric quaternary ammonium | Hypan ® QT 100 |
| | 139767-67-7 | salt, which is produced by reacting | |
| | | DMAPA acrylates/acrylic | |
| | | acid/acrylonitrogen copolymer and | |
| | | diethyl sulfate | |
| Polyquaternium-32 | CAS 35429-19-7 | N,N,N-trimethyl-2-[(2-methyl-1-oxo- | |
| | | 2-propenyl)oxy]ethaneaminium | |
| | | chloride, polymer with 2- | |
| | | propenamide | |
| Polyquaternium-37 | CAS 26161-33-1 | | |
| Polyquaternium-44 | | Copolymeric quaternary ammonium | |
| | | salt of vinylpyrrolidone and | |
| | | quaternized imidazoline | |

In addition, protein hydrolyzates can be used, as can conditioning substances based on silicone compounds, for example polyalkylsiloxanes, polyarylsiloxanes, polyarylalkylsiloxanes, polyether siloxanes or silicone resins. Further suitable silicone compounds are dimethicone copolyols (CTFA) and amino-functional silicone compounds such as amodimethicones (CTFA).

### Soaps and Syndets

Further compositions according to the invention which comprise the polymers according to the invention are, for example, soaps and syndets.

Soap is formed in the reaction of a (neutral) fat or fatty acids or fatty acid methyl esters obtained therefrom with sodium hydroxide or potassium hydroxide solution (saponification). Soap is chemically the alkali metal salt of fatty acids in the composition. The neutral fats usually used in the manufacture of soap are beef tallow or palm oil in a mixture with coconut oil or palm kernel oil and—more rarely—other natural oils or fats, where the quality of the starting fats is highly influential on the quality of the soap obtained therefrom.

Of importance for selecting the fatty components is the distribution of the chain lengths of the corresponding fatty acids. Normally, especially C12-C18-fatty acids are in demand. Since laurate soap foams particularly well, lauric-rich coconut oil or the similarly composed palm kernel oil is usually used in relatively high fractions (up to 50% of the neutral fatty mixture) for soaps for which a large amount of foam during use is desired.

The sodium salts of the specified fatty acid mixtures are solid, whereas the potassium salts are soft and pasty. For this reason, the alkali solution component used for producing solid soaps is preferably sodium hydroxide solution, and for liquid-pasty soaps is preferably potassium hydroxide solution. During the saponification, the ratio of alkali solution to fatty acid is selected so that, at most, a minimum excess of alkali solution (max. 0.05%) is present in the finished soap bar.

The soaps usually include toilet, curd, transparent, luxury, cream, freshening/deodorant, baby, skin protection, abrasive, floating and liquid soaps and also washing pastes and soap leaves.

Besides the polymers according to the invention, soaps according to the invention advantageously furthermore comprise antioxidants, complexing agents and humectants and also, if appropriate, fragrances, dyes and further cosmetically acceptable ingredients. Such further suitable ingredients are specified above. Syndets (synthetic detergents) are alternatives to conventional soaps which have certain advantages as a result of the varying composition compared to soap, whereas soap more likely has disadvantages.

Syndets comprise, as foam and cleaning components, washing-active substances (surfactants), which are obtained by chemical synthesis. By contrast, soaps are—as described—salts of naturally occurring fatty acids. For syndets, skin-mild, readily biodegradable surfactants are used, preferably fatty acid isethionates (sodium cocoyl isethionate), sulfosuccinic acid half-esters (disodium lauryl sulfosuccinate), alkyl polyglucosides (decyl glucoside), amphoteric surfactants (e.g. sodium cocoamphoacetate). In addition, monoglyceride sulfate and ether carboxylates sometimes play a role. Fatty alcohol sulfate (e.g. sodium lauryl sulfate) has largely lost its former significance as base surfactant for syndets. The base surfactants are combined with builder substances, refatting agents and further additives to give formulations which can be processed by customary soap technology and produce bars which behave as far as possible in a “soap-like” manner, but without the mentioned disadvantages of soap. They foam at every water hardness and have a very good cleaning power. Their pH can be adjusted within a wide range (mostly between 4 and 8).

On account of the more intensive cleaning/degreasing power of the base surfactants, the surfactant fraction in the syndet is usually significantly lower, the fraction of superfatting agents is significantly higher than in soaps, without the foaming ability being reduced. Syndets are recommended specifically for the cleansing of sensitive skin, of youthful-blemished skin and for face washing.

Alongside the (soap-free) syndets is also found the market segment of half—or combars (derived from combination bar). These are bars which comprise both soap and also syndet surfactants. Combars comprise 10 to 80% by weight of soap. They represent a compromise between soaps and syndets for the criteria of costs, foaming ability, skin feel and compatibility. When washing with a combar, a pH of from about 7 to 9 is established, depending on its soap fraction.

As regards possible formulations for soaps and syndets known to the person skilled in the art, reference may be made to “Kosmetik and Hygiene von Kopf bis Fuβ” [“Cosmetics and hygiene from head to toe”], ed. W. Umbach, 3rd edition, Wiley-VCH, 2004, pp. 112-122, to which reference is made at this point in its entirety.

### Shower Bath and Bathing Products

As regards specific compositions for shower bath and bathing products or washing lotions, reference may be made to “Kosmetik and Hygiene von Kopf bis Full” [“Cosmetics and hygiene from head to toe”], ed. W. Umbach, 3rd edition, Wiley-VCH, 2004, pp. 128-134, to which reference is made at this point in its entirety.

The invention further provides the use of a polymer according to the invention as thickener in pharmacy for modifying rheological properties.

The polymers according to the invention are furthermore particularly suitable as thickeners in hair gels, in particular so-called styling gels. A preparation suitable according to the invention for styling gels can, for example, have the composition as follows:

a) 60-99.85% by weight of water and/or alcohol
b) 0.05-10% by weight of a polymer according to the invention
c) 0-20% by weight of further constituents.

The polymers according to the invention can be used as gel formers on their own or together with further customary gel formers. Such further customary gel formers are lightly crosslinked polyacrylic acid, for example Carbomer (INCI), cellulose derivatives, e.g. hydroxypropylcellulose, hydroxyethylcellulose, cationically modified celluloses, polysaccharides, e.g. xanthum gum, caprylic/capric triglycerides, sodium acrylates copolymer, Polyquaternium-32 (and) paraffinum liquidum (INCI), sodium acrylates copolymer (and) paraffinum liquidum (and) PPG-1 trideceth-6, acrylamidopropyl trimonium chloride/acrylamide copolymer, steareth-10 allyl ether acrylates copolymer, Polyquaternium-37 (and) paraffinum liquidum (and) PPG-1 trideceth-6, Polyquaternium 37 (and) propylene glycol dicaprate dicaprylate (and) PPG-1 trideceth-6, Polyquaternium-7, Polyquaternium-44.

### EXAMPLES

Meaning of the abbreviations/trade names:

| | |
|---|---|
| AA | acrylic acid |
| MAA | methacrylic acid |
| VP | N-vinylpyrrolidone |
| VI | N-vinylimidazole |
| HEMA | hydroxyethyl methacrylate |
| Plex ®6877 O | 25% strength solution of C₁₈-alkyl PEG₁₁₀₀ methacrylate |
| | in methyl methacrylate (Degussa) |
| Trigonox ®101 | 2,5-dimethyl-2,5-di(tert-butylperoxy)hexane |
| TBPOC | tert-butyl peroctoate |

### Preparation of the Copolymers

The preparation of the copolymer of example 5 is described here by way of example: Poly(VP/VI/AA/PLEX®6877 O) 50/5/35/10 (weight ratio))

| | | |
|---|---|---|
| Initial charge: | 412 g | butyl acetate |
| | 0.15 g | Trigonox ®101 |
| Feed 1: | 75 g | vinylpyrrolidone |
| | 7.5 g | vinylimidazole |
| | 52.5 g | acrylic acid |
| | 15.0 g | Plex ®6877 O |
| Feed 2: | 40 g | butyl acetate |
| | 0.10 g | tert-butyl peroctoate |
| Feed 3: | 100 g | butyl acetate |
| | 0.15 g | tert-butyl peroctoate |
| | 0.10 g | Trigonox ®101 |

At 87-88° C., feed 1 and feed 2 were added over the course of two hours to a stirred apparatus with reflux condenser, internal thermometer and four feed devices. The reaction mixture was further stirred for 3 hours at about 88° C. Feed 3 was metered in over the course of 30 minutes and the resulting mixture was stirred for a further 3 hours at 90° C. The reaction mixture was then afterpolymerized for 2 hours at 120° C. After cooling to about 40° C., the precipitated white polymer powder was sucked off via a suction filter, washed twice with acetone and dried at 40° C. in vacuo.

The other polymers in the table below were also prepared in accordance with these instructions.

The quantitative data in the table below are % by weight

| Example | VP | VI | M | MAA | HEMA | Plex ®6877 O |
|---|---|---|---|---|---|---|
| 1 | 98.5 | 1 | — | 0.5 | — | — |
| 2 | 95 | 4.5 | — | 0.5 | — | — |
| 3 | 86 | 12 | — | 2 | — | — |
| 4 | 80 | 5 | — | 15 | — | — |
| 5 | 50 | 5 | 35 | — | — | 10 |
| 6 | 50 | 36 | — | 4 | — | 10 |
| 7 | 73 | 2 | 15 | — | 10 | — |
| 8 | 73 | 2 | — | 15 | 10 | — |
| 9 | 63 | 2 | 15 | — | 10 | — |
| 10 | 45 | 5 | 20 | — | 30 | — |
| 11 | 42 | 3 | 35 | — | 20 | — |
| 12 | 40 | — | 40 | — | 10 | 10 |

1.-12. (canceled)

13. A process for preparing polymers which comprises polymerizing a monomer mixture which comprises
a) 30 to 99% by weight of at least one nonionic water-soluble monomer,
b) at least one monomer different from a) selected from
i) monomers carrying at least one hydroxyl group,
ii) anionic monomers,
iii) mixtures of i) and ii),
c) optionally a monomer carrying at least one amino group, and
d) optionally further monomers,
where the total amount of a), b), c) and d) is 100% by weight and where the monomer mixture, based on the total amount of a), b), c) and d), comprises less than 0.1% by weight of a monomer with at least 2 free-radically polymerizable double bonds per molecule, wherein the polymerization is a precipitation polymerization.

14. The process according to claim 13, where the monomer mixture comprises
a) 30 to 99% by weight of at least one nonionic water-soluble monomer,
b) at least one monomer different from a) selected from
i) monomers carrying at least one hydroxyl group,
ii) anionic monomers,
iii) mixtures of i) and ii),
with the proviso that the monomer mixture furthermore comprises
c) at least one monomer carrying at least one amino group, if b) is selected from ii) or iii), and
d) optionally further monomers,
where the total amount of a), b), c) and d) is 100% by weight and where the monomer mixture, based on the total amount of a), b), c) and d), comprises less than 0.1% by weight of a monomer with at least 2 free-radically polymerizable double bonds per molecule.

15. The process according to claim 14, where the monomer mixture comprises
a) 30 to 85% by weight of at least one nonionic water-soluble monomer,
b) at least one anionic monomer,
c) at least one free-radically polymerizable imidazole compound, and
d) optionally further monomers d),
where
the total amount of a), b), c) and d) is 100% by weight and
the monomer mixture, based on the total amount of a), b), c) and d), comprises less than 0.1% by weight of a monomer with at least 2 free-radically polymerizable double bonds per molecule and
the total amount of b)+c), based on the total amount of a), b), c) and d), is in the range from 15 to 70% by weight and
the ratio of the molar amounts of b) to c) is not in the range from 1:2 to 2:1.

16. The process according to claim 13, where a) is selected from the group consisting of N-vinyllactams and derivatives thereof, N-vinylamides of saturated C₁-C₈-monocarboxylic acids, primary amides of α,β-ethylenically unsaturated monocarboxylic acids and the N-alkyl and N,N-dialkyl derivatives thereof, which, in addition to the carbonyl carbon atom of the amide group, have at most 8 further carbon atoms, esters of α,β-ethylenically unsaturated mono- and dicarboxylic acids with diols, amides of α,β-ethylenically unsaturated mono- and dicarboxylic acids with amino alcohols, which have a primary or secondary amino group, polyether acrylates and mixtures thereof.

17. The process according to claim 13, where a) is selected from the group consisting of N-vinylpyrrolidone, N-vinylcaprolactam, (meth)acrylamide and N-vinylformamide.

18. The process according to claim 13, where b) is or comprises (meth)acrylic acid.

19. The process according to claim 17, where b) is or comprises (meth)acrylic acid.

20. The process according to claim 13, where c) is or comprises N-vinylimidazole.

21. The process according to claim 19, where c) is or comprises N-vinylimidazole.

22. The process according to claim 13, where d) is or comprises a polyether (meth)acrylate.

23. The process according to claim 21, where d) is or comprises a polyether (meth)acrylate.

24. The process according to claim 13, where the monomer mixture comprises
a) 30 to 85% by weight of monomer a),
b) 3 to 40% by weight of monomer b),
c) 3 to 40% by weight of monomer c) and
d) 0.1 to 15% by weight of monomer d).

25. The process according to claim 23, where the monomer mixture comprises
a) 30 to 85% by weight of monomer a),
b) 3 to 40% by weight of monomer b),
c) 3 to 40% by weight of monomer c) and
d) 0.1 to 15% by weight of monomer d).

26. A polymer obtainable by a process according to claim 13.

27. A thickener comprising the polymer according to claim 26.

28. A cosmetic preparation comprising at least one of the polymers according to claim 26.
